(19) United States
(12) Patent Application Publication
(10) Pub. No.: US 2011/0093185 A1
(43) Pub. Date: Apr. 21, 2011

(54) METHOD FOR OPERATING AN INTERNAL COMBUSTION ENGINE SYSTEM

(75) Inventors: Federico Luigi GUGLIELMONE, Rivoli (IT); Federico FERRERO, Caselette (IT)

(73) Assignee: GM GLOBAL TECHNOLOGY OPERATIONS, INC., Detroit, MI (US)

(21) Appl. No.: 12/906,927

(22) Filed: Oct. 18, 2010

(30) Foreign Application Priority Data
Oct. 19, 2009 (GB) 0918275.9

(51) Int. Cl. F02D 21/08

(52) U.S. Cl. 701/108

(57) ABSTRACT

A method for operating an internal combustion engine system includes, but is not limited to a combustion engine having intake manifold and exhaust manifold, a first EGR route for conveying exhaust gas from exhaust manifold to intake manifold, a second EGR route configured for conveying to the intake manifold exhaust gas having lower temperature than that conveyed through the first EGR route, and regulator for regulating the flow rate of exhaust gas through the first and the second EGR route. The method includes, but is not limited to determining a first setpoint value for the total amount of exhaust gas requested into the intake manifold, determining a second setpoint value for a parameter representative of the relationship between the total amount of exhaust gas requested into the intake manifold, the amount of exhaust gas from the first EGR route and from the second EGR route, applying said first and second set-point values to a control routine for adjusting the regulating means accordingly, determining a third setpoint value for the temperature in the intake manifold, determining the actual temperature in the intake manifold, calculating the error between said actual temperature and the third setpoint value, and using said error for generating a correction index to be applied to the second setpoint value, in order to minimize said error.

### CROSS-REFERENCE TO RELATED APPLICATION

This application claims priority to British Patent Application No. 0918275.9, filed Oct. 19, 2009, which is incorporated herein by reference in its entirety.

### TECHNICAL FIELD

The present invention relates to a method for operating an internal combustion engine system, in particular a turbocharged Diesel engine system.

### BACKGROUND

A turbocharged Diesel engine system generally comprises a Diesel engine having an intake manifold and an exhaust manifold, an intake line for conveying fresh air from the environment in the intake manifold, an exhaust line for conveying the exhaust gas from the exhaust manifold to the environment, and a turbocharger which comprises a compressor located in the intake line for compressing the air stream flowing therein, and a turbine located in the exhaust line for driving said compressor.

The turbocharged Diesel engine system further comprises an inter-cooler located in the intake line downstream the compressor, for cooling the air stream before it reaches the intake manifold, and a diesel oxidation catalyst (DOC) located in the exhaust line down-stream the turbine, for degrading residual hydrocarbons and carbon oxides contained in the exhaust gas. The turbocharged Diesel engine systems can also be equipped with a diesel particulate filter (DPF) located in the exhaust line down-stream the DOC, for capturing and removing diesel particulate matter (soot) from the exhaust gas.

In order to reduce the polluting emission, most turbocharged Diesel engine system actually comprises an exhaust gas recirculation (EGR) system, for selectively routing back exhaust gas from the exhaust manifold into the intake manifold. The exhaust gas mixed with the fresh induction air is aspired into the engine cylinders, in order to reduce the production of unburned hydrocarbon (HC), carbon monoxide (CO), soot, and oxides of nitrogen (NOx) during the combustion process.

Conventional EGR systems comprise an EGR conduit for fluidly connecting the exhaust manifold with the intake manifold, an EGR cooler for cooling the exhaust gas before mixing it with the induction air, valve means for regulating the flow rate of exhaust gas through the EGR conduit, and a microprocessor based controller (ECU) for determining the required amount of exhaust gas and for controlling said valve means accordingly.

The required amount of exhaust gas is generally determined by the ECU using an empirically determined data set or map, which correlates the amount of exhaust gas to a plurality of engine operating parameters, such as for example engine speed, engine load and engine coolant temperature.

Since the EGR conduit directly connect the exhaust manifold with the intake manifold, the exhaust gas routed back by these conventional EGR systems is at high temperature and cause a relevant temperature increase of the induction air in the intake manifold, typically up to 80° C.-90° C. in normal engine operating conditions. While an high temperature of the induction air is useful for reducing HC and CO emissions, it promote the production NOx, whose emission cannot be maintained below the threshold provided for by the strictest standards, such as for example by Euro 6.

In order to further reduce the NOx emission, have been considered improved EGR systems comprising an additional EGR conduit, which flu-idly connects the exhaust line downstream the DPF with the intake line upstream the compressor of turbocharger, an additional EGR cooler located in the additional EGR conduit, and additional valve means for regulating the flow rate of exhaust gas through the additional EGR conduit.

In these improved systems, while the conventional EGR conduit defines a short route for the exhaust gas recirculation, the additional EGR conduit defines a long route for the exhaust gas recirculation, which comprises also a relevant portion of the exhaust line and a relevant portion of the intake line.

Flowing along the long route, the exhaust gas is then obliged to pass through the turbine of turbocharger, the DOP, the DPF, the additional EGR cooler, the compressor of turbocharger and the intercooler, so that it become considerably colder than the exhaust gas which flows through the short route, to thereby reaching the intake manifold at a lower temperature. As a matter of fact, routing back the exhaust gas through the long route only, it would be possible, in normal engine operating conditions, to obtain an induction air temperature in the intake manifold around 40° C.-50° C. However a so low temperature of the induction air is not admissible, because it is suitable for reducing NOx emission but increases the HC and Co emissions.

Therefore, these improved EGR systems are generally configured for routing back the exhaust gas partially through the short route and partially through the long route, in order to maintain the temperature of the induction air in the intake manifold at an optimal intermediate value in any engine operating condition. Such optimal intermediate value is determined during engine project activity, with the purpose of obtaining a satisfactory compromise between the reduction of NOx emission and the increasing of HC and Co emissions.

In production, these improved EGR systems are then provided with a microprocessor base controller (ECU) which is configured for deter-mining the total amount of exhaust gas required, for determining the long route exhaust gas rate which is necessary for obtaining the de-sired optimal temperature, and for controlling the valve means of both EGR conduits accordingly. The total amount of exhaust gas and the long route exhaust gas rate are determined by the ECU using empirically determined data sets or maps, which respectively correlates the total amount of exhaust gas and the long route exhaust gas rate to a plurality of engine operating parameters, such as for example engine speed, engine load and engine coolant temperature.

One drawback of these improved EGR systems is that such data sets or maps are determined during a calibration activity, using an engine system perfectly efficient which is operated under standard environ-mental conditions, i.e., standard environmental temperature, pressure and moisture. Therefore, the value contained in the data sets or maps are valid only for engine systems which are operated in the same environmental conditions of that used in calibration phase, and completely ignore the reduction in efficiency of the engine system components due to their aging.

For example, it has been observed that cooler devices, such as for example intercooler and EGR coolers, shows a progressive reduction in performance. Such reduction in performance implies that the temperature of exhaust gas to be mixed with the fresh engine induction air increases, due to the reduction of heat transfer between the exhaust gas and the cool-ant of the coolers. In this case, the long route EGR rate, provided by the empirical data sets or maps, does not permit to obtain the predetermined optimal temperature value for the engine induction air in the intake manifold, but realizes a higher temperature which increases NOx emission with respect to that expected.

More generally, it has been observed that any variation in environ-mental conditions or components efficiency with respect to the reference ones considered during calibration activity, leads to a variation of exhaust gas temperature which results in emission spread compared with the desired one.

At least one object of the present invention is to solve, or at least to positively reduce, the above mentioned drawbacks with a simple, rational and inexpensive solution. In addition, other objects, desirable features, and characteristics will become apparent from the subsequent summary and detailed description, and the appended claims, taken in conjunction with the accompanying drawings and this background.

### SUMMARY

A method is provided for operating an internal combustion engine system, the internal combustion engine system comprising a combustion engine having an intake manifold and an exhaust manifold, a first EGR route for conveying exhaust gas from the exhaust manifold into intake manifold, a second EGR route for conveying exhaust gas from the exhaust manifold into intake manifold, wherein the second EGR route is configured for conveying into the intake manifold exhaust gas having lower temperature than that conveyed through the first EGR route, and regulating means for regulating the flow rate of exhaust gas through the first EGR route and the flow rate of exhaust gas through the second EGR route.

The method comprises the steps of determining a first setpoint value for the total amount of exhaust gas requested into the intake manifold, determining a second setpoint value for a parameter representative of the relationship between the total amount of exhaust gas re-quested into the intake manifold, the amount of exhaust gas from the first EGR route, and the amount of exhaust gas from the second EGR route, applying said first and second setpoint values to a control routine for adjusting the regulating means accordingly.

The method further comprises the steps of determining a third setpoint value for the temperature within the intake manifold; determining the actual temperature within the intake manifold; calculating the error between said actual temperature and the third setpoint value, and using said error for generating a correction index to be applied to the second setpoint value, in order to minimize said error.

As a matter of fact, the method performs an external control loop of the induction air temperature in the intake manifold, which is able to continuously correct the rate of exhaust gas coming from the first and second EGR route, in order to compensate eventual variations in environmental conditions and/or in engine component efficiency, to thereby obtaining a desired temperature value in any engine operating conditions.

According to an embodiment of the invention, the parameter expressed by the second setpoint value is the rate of exhaust gas from the second EGR route on the total amount of exhaust gas requested into the intake manifold. Alternatively, such parameter would be the rate of exhaust gas from the first EGR route, or the rate between the exhaust gas from the first EGR route and the exhaust gas from the second EGR route.

According to another embodiment of the invention, the actual temperature within the intake manifold is determined by measuring temperature therein, for example through a temperature sensor set inside the inlnposelstartlnposelendlnposelstartlnposelendtake manifold. However, the intake manifold temperature would eventually be estimated.

According to another embodiment of the invention, the correction index is added to the second setpoint value. According to another embodiment of the invention, the second setpoint value and the third setpoint value are both determined from empirically determined data sets or maps, which respectively correlates the “parameter” and the intake manifold temperature to a plurality of engine operating parameters, such as for example engine speed, engine load and engine coolant temperature.

The method according to embodiments of the invention can be realized in the form of a computer program comprising a program-code to carry out all the steps of the method of the invention, and in the form of a computer program product comprising means for executing the computer program.

The computer program product comprises, according to a preferred embodiment, a microprocessor based control apparatus for an IC engine, for example the ECU of the engine, in which the program is stored so that the control apparatus defines the invention in the same way as the method. In this case, when the control apparatus execute the computer program all the steps of the method according to embodiments of the invention are carried out.

The method according to the invention can be also realized in the form of an electromagnetic signal, said signal being modulated to carry a sequence of data bits which represent a computer program to carry out all steps of the method of the invention.

### BRIEF DESCRIPTION OF THE DRAWINGS

:

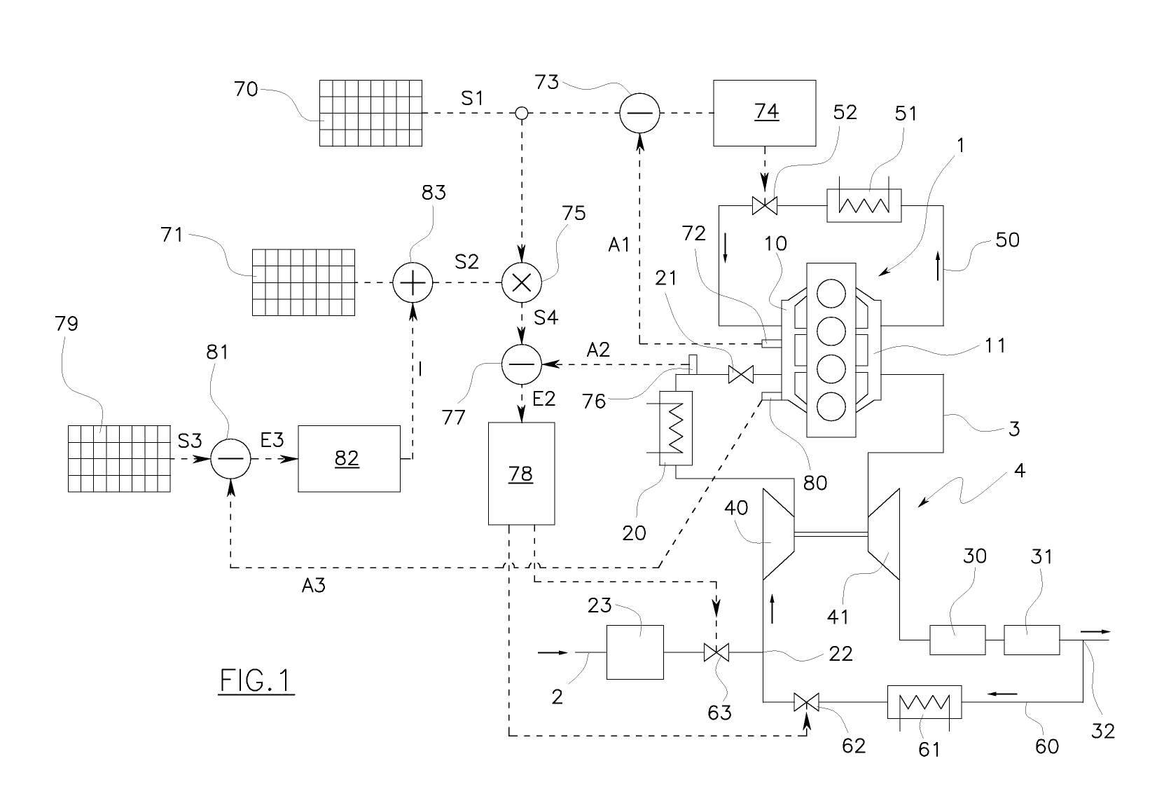

The present invention will hereinafter be described in conjunction with the following drawing FIG. 1, which is schematic illustration of a turbocharged Diesel engine system allowing the method according to an embodiment of the invention.

### DETAILED DESCRIPTION

The following detailed description is merely exemplary in nature and is not intended to limit application and uses. Furthermore, there is no intention to be bound by any theory presented in the preceding background or summary or the following detailed description.

The turbocharged Diesel engine system comprises a Diesel engine 1 having an intake manifold 10 and an exhaust manifold 11, an intake line 2 for conveying fresh air from the environment in the intake manifold 10, an exhaust line 3 for conveying the exhaust gas from the exhaust manifold 11 to the environment, and a turbocharger 4 which comprises a compressor 40 located in the intake line 2 for compressing the air stream flowing therein, and a turbine 41 located in the exhaust line 3 for driving said compressor 40.

The turbocharged Diesel engine system further comprises an inter-cooler 20 located in the intake line 2 downstream the compressor 40 of turbocharger 4, for cooling the air stream before it reaches the intake manifold 10, and a valve 21 located in the intake line between the intercooler 20 and the intake manifold 10.

The turbocharged Diesel engine system further comprises a diesel oxidation catalyst (DOC) 30 located in the exhaust line 3 downstream the turbine 41 of turbocharger 4, for degrading residual hydrocarbons and carbon oxides contained in the exhaust gas, and a diesel particulate filter (DPF) 31 located in the exhaust line 3 downstream the DOC 30, for capturing and removing diesel particulate matter (soot) from the exhaust gas.

In order to reduce the polluting emission, the turbocharged Diesel engine system comprises an exhaust gas recirculation (EGR) system, for selectively routing back exhaust gas from the exhaust manifold into the intake manifold.

The EGR system comprise a first EGR conduit 50 for directly fluidly connecting the exhaust manifold 11 with the intake manifold 12, a first EGR cooler 51 for cooling the exhaust gas, and a first electrically controlled valve 52 for determining the flow rate of exhaust gas through the first EGR conduit 51. The first EGR conduit 51 defines a short route for the exhaust gas recirculation cooler, so that the exhaust gas routed back by this first EGR conduit 51 is quite hot.

The EGR system further comprise a second EGR conduit 60, which flu-idly connects a branching point 32 of the exhaust line 3 downstream the DPF 31 with a leading point 22 of the intake line 2 upstream the compressor 40 of turbocharger 4, and a second EGR cooler 61 located in the additional EGR conduit 60. The flow rate of exhaust gas through the second EGR conduit 60 is determined by two second electrically controlled valves 62 and 63, wherein the valve 62 is located in the second EGR conduit 60 down-stream the second EGR cooler 61, and the valve 63 is located in the intake line 2 downstream an air filter 23 and upstream the leading point 22.

The second EGR conduit 60 defines a long route for the exhaust gas recirculation, which comprises also the portion of the exhaust line 3 comprised between the exhaust manifold 11 and the branching point 32, and the portion of the intake line 2 comprised between the leading point 22 to the intake manifold 10.

Flowing along the long route, the exhaust gas is obliged to pass through the turbine 41 of turbocharger 4, the DOP 30, the DPF 31, the second EGR cooler 61, the compressor 40 of turbocharger 4 and the intercooler 20, so that it become considerably colder than the exhaust gas which flows through the first EGR conduit 50, to thereby reaching the intake manifold at a lower temperature.

The turbocharged Diesel engine system is operated by a microprocessor (ECU) based control circuit, which is provided for generating and applying control signals to the valves 52, 62 and 63, to thereby adjusting the flow rate of exhaust has through the first EGR conduit 50 and the second EGR conduit 60. The control circuit is that represented with dotted lines in FIG. 1.

The control circuit determines a setpoint value S1 for the total amount of exhaust gas which is requested into the exhaust manifold 11, and a setpoint value S2 for the requested rate of long route exhaust gas on said total amount, that is the percentage of exhaust gas on the total which must come from the second EGR conduit 60. The remaining percentage of exhaust gas comes from the first EGR conduit 50.

The setpoint value S1 is determined by the ECU from an empirical determined map 70 which correlates the requested total amount of exhaust gas to a plurality of engine operating parameters, such as engine speed, engine load and engine coolant temperature. The setpoint value S2 is determined by the ECU from another empirical determined map 71 which correlates the long route exhaust rate to a plurality of engine operating parameters, such as engine speed, engine load and engine coolant temperature. The maps 70 and 71 are stored in a memory module (not shown) of the control circuit. The control circuit determines the actual amount A1 of exhaust gas which is present into the intake manifold 10.

The determination of the amount A1 is provided through an estimation which is performed by ECU using a physical model of turbocharger the Diesel engine system, and which is illustrated as a virtual sensor 72 in FIG. 1. The determination of the amount A1 would eventually be performed through the determination of another physical parameter, which is directly related with the amount of exhaust gas, such as for example the oxygen (O2) concentration. The determination of the amount A1 would also be provided by measuring the amount of exhaust gas, or another physical parameter related with the amount of exhaust gas, through a sensor set into the intake manifold 10.

The determined value A1 of the amount of exhaust gas into the intake manifold 10 is sent to an adder 73, which calculates the difference E1 between the setpoint value S1 and said determined value A1:

E1=S1−A1

The difference E1 is supplied to a controller 74, for instance a PI controller, which in function of the above named difference, generates a correction which is applied to the control signal of the valve 52, in order adjust the flow rate of exhaust gas through the first EGR conduit 50 for minimizing said difference E1.

Contemporaneously the setpoint value S1 and the setpoint value S2 are sent to a multiplier 75, which calculates another setpoint value S4 for the amount of exhaust gas which is requested coming from the second EGR conduit 60:

S4=S1*S2

Contemporaneously, the control circuit determine the actual amount A2 of exhaust gas into the intake line 2 upstream the valve 21 and down-stream the intercooler 20, which is the actual amount of exhaust gas supplied by the second EGR conduit 60.

The determination of the amount A2 is provided through an estimation which is performed by ECU using a physical model of turbocharger the Diesel engine system, and which is illustrated as a virtual sensor 76 in FIG. 1. The determination of the amount A2 would eventually be performed through the determination of another physical parameter, which is directly related with the amount of exhaust gas, such as for example the oxygen (O2) concentration. The determination of the amount A2 would also be provided by measuring the amount of exhaust gas, or another physical parameter related with the amount of exhaust gas, through a sensor set into the intake line 2 between intercooler 20 and valve 21. The determined value A2 is sent to an adder 77, which calculates the difference E2 between the setpoint value S4 and said determined value A2:

E2=S4−A2

The difference E2 is supplied to a controller 78, for instance a PI controller, which in function of the above named difference, generates a correction which is applied to the control signal of the valve 62 and or 63, in order adjust the flow rate of exhaust gas through the second EGR conduit 60 for minimizing said difference E2. As a matter of fact, the control circuit performs a control loop of the total amount of exhaust gas in the intake manifold, and a control loop of the amount of exhaust gas supplied by the second EGR conduit 60 on the total amount, which are able to continuously correct the flow rate of exhaust gas through the first and the second EGR conduit, 50 and 60, in order to actually reaching the setpoint values S1 and S2.

According to an embodiment of the invention, contemporaneously with the preceding steps, the control circuit further determines a setpoint value S3 for the temperature within the intake manifold 10. The setpoint value S3 is determined by the ECU from an empirical determined map 79 which correlates the intake manifold temperature to a plurality of engine operating parameters, such as engine speed, engine load and engine coolant temperature. The maps 79 is stored in a memory module (not shown) of the control circuit.

The control circuit determines the actual temperature A3 within the intake manifold 10. The actual temperature A3 is determined by measuring temperature within the intake manifold through a temperature sensor 80. Alternatively, the intake manifold temperature A3 would eventually be estimated. The determined temperature value A3 is sent to an adder 81, which calculates the difference E3 between the setpoint value S3 and said determined value A3:

E3=S3−A3

The difference E3 is supplied to a controller 82, for instance a PI controller, which in function of the above named difference, generates a correction index I to be applied to the setpoint value S2, in order to modify the setpoint value S2 upstream the multiplier 75, in order to minimize said error E3. As a matter of fact, the correction index I is sent to an adder 83, which adds the correction index I to the setpoint S2, before the latter is sent to the multiplier 75. The correction index I can be also a negative number.

In this way, the control circuit performs an external control loop of the induction air temperature in the intake manifold 10, which is able to continuously correct the rate of exhaust gas coming from the first and the second EGR conduit, 50 and 60, in order to compensate eventual variations in environmental conditions and/or in engine component efficiency, to thereby obtaining a desired temperature value S3 in any engine operating conditions.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for operating an internal combustion engine system, said internal combustion engine system comprising:
a combustion engine having an intake manifold and an exhaust manifold;
a first EGR route adapted to convey exhaust gas from the exhaust manifold into the intake manifold;
a second EGR route adapted to convey exhaust gas from the exhaust manifold into the intake manifold, said second EGR route configured to convey into the intake manifold exhaust gas having a lower temperature than that conveyed through the first EGR route; and
a regulator adapted to regulate a flow rate of exhaust gas through the first EGR route and a flow rate of exhaust gas through the second EGR route,
the method comprising the steps of:
determining a first setpoint value for a total amount of exhaust gas requested into the intake manifold;
determining a second setpoint value for a parameter representative of a relationship between the total amount of exhaust gas requested into the intake manifold, an amount of exhaust gas from the first EGR route, and the amount of exhaust gas from the second EGR route;
applying said first setpoint value and the second setpoint value to a control routine for adjusting the regulator;
determining a third setpoint value for a temperature within the intake manifold;
determining an actual temperature within the intake manifold;
calculating an error between said actual temperature and the third setpoint value; and
generating a correction index (I) using said error for application to the second setpoint value in order to reduce said error.

2. The method according to claim 1, wherein the parameter expressed by the second setpoint value is a rate of exhaust gas from the second EGR route on the total amount of exhaust gas requested into the intake manifold.

3. The method according to claim 1, wherein the actual temperature within the intake manifold is determined by measuring the temperature within the intake manifold.

4. The method according to claim 1, wherein said correction index (I) is added to the second setpoint value.

5. The method according to claim 1, wherein said second setpoint value is empirically determined and correlates said parameter to a plurality of engine operating parameters.

6. The method according to claim 1, wherein said third setpoint value is empirically determined and correlates the temperature within the intake manifold to a plurality of engine operating parameters.

7. The method according to claim 5, wherein said plurality of engine operating parameters are chosen from a group comprising engine speed, engine load or engine coolant temperature.

8. The method according to claim 1, wherein the internal combustion engine system further comprises:
an intake line adapted to convey air from an environment into the intake manifold; and
an exhaust line adapted to conveying exhaust gas from the exhaust manifold to the environment,
wherein the first EGR route comprises a first EGR conduit that fluidly connects the exhaust manifold with the intake manifold,
wherein the second EGR route comprises a second EGR conduit that fluidly connects a point of the exhaust line downstream the exhaust manifold with a point of the intake line that is up-stream from the intake manifold,
wherein the regulator comprises a first valve adapted to regulate the flow rate of exhaust gas through the first EGR conduit and a second valve adapted to regulate the flow rate of exhaust gas through the second EGR conduit,
wherein the method further comprises the steps of:
determining an actual amount of exhaust gas into the intake manifold;
calculating the error between said actual amount of exhaust gas and the first setpoint value;
generating a correction using said error to be applied to a first control signal of the first valve in order to adjust the flow rate of exhaust gas for minimizing said error;
calculating a fourth setpoint value using the first setpoint value and the second setpoint value for the amount of exhaust gas requested from the second EGR route;
determining the actual amount of exhaust gas into the intake line upstream the intake manifold and downstream the second EGR conduit;
calculating the error between said actual amount of exhaust gas in the intake line and the fourth setpoint value;
generating the correction using said error to be applied to a second control signal of the second valve in order adjust the flow rate of exhaust gas for reducing said error.

9. The method according to claim 8, wherein the internal combustion engine system further comprises:
a turbocharger having a compressor located in the intake line and a turbine located in the exhaust line adapted to drive the compressor,
wherein the second EGR conduit fluidly connects a point of the exhaust line downstream the turbine and a point of the intake line upstream the compressor, and
wherein the determining of the actual amount of exhaust gas into the intake line provides for determining such actual amount downstream the compressor.

10. The method according to claim 8, wherein the internal combustion engine system further comprises:
a first EGR cooler located in the first EGR conduit;
a second EGR cooler located in the second EGR conduit; and
an intercooler located in the intake line upstream of the intake manifold and downstream the second EGR conduit,
wherein the determining of the actual amount of exhaust gas into the intake line provides for determining such actual amount downstream the intercooler.

11. The method according to claim 8, wherein the determining of the actual amount of exhaust gas into the intake manifold and the determining of the actual amount of exhaust gas into the intake line are provided with a respective model-based estimation.

12. An internal combustion engine system, comprising:
a combustion engine having an intake manifold and an exhaust manifold;
a first EGR route adapted to convey exhaust gas from the exhaust manifold into the intake manifold;
a second EGR route adapted to convey exhaust gas from the exhaust manifold into the intake manifold, said second EGR route configured to convey into the intake manifold exhaust gas having a lower temperature than that conveyed through the first EGR route; and
a regulator adapted to regulate a flow rate of exhaust gas through the first EGR route and a flow rate of exhaust gas through the second EGR route; and
a processor configured to:
determine a first setpoint value for a total amount of exhaust gas requested into the intake manifold;
determine a second setpoint value for a parameter representative of a relationship between the total amount of exhaust gas requested into the intake manifold, an amount of exhaust gas from the first EGR route, and the amount of exhaust gas from the second EGR route;
apply said first setpoint value and the second setpoint value to a control routine for adjusting the regulator;
determine a third setpoint value for a temperature within the intake manifold;
determine an actual temperature within the intake manifold;
calculate an error between said actual temperature and the third setpoint value; and
generate a correction index (I) using said error for application to the second setpoint value in order to reduce said error.

13. The internal combustion engine system according to claim 12, wherein the parameter expressed by the second setpoint value is a rate of exhaust gas from the second EGR route on the total amount of exhaust gas requested into the intake manifold.

14. The internal combustion engine system according to claim 12, wherein the actual temperature within the intake manifold is determined by measuring the temperature within the intake manifold.

15. The internal combustion engine system according to claim 12, wherein said correction index (I) is added to the second setpoint value.

16. A computer readable medium embodying a computer program product, said computer program product comprising:
a program for operating an internal combustion engine system, said internal combustion engine system comprising a combustion engine having an intake manifold and an exhaust manifold, a first EGR route adapted to convey exhaust gas from the exhaust manifold into the intake manifold, a second EGR route adapted to convey exhaust gas from the exhaust manifold into the intake manifold, said second EGR route configured to convey exhaust gas into the intake manifold that has a lower temperature than that conveyed through the first EGR route, and a regulator adapted to regulate a flow rate of exhaust gas through the first EGR route and a flow rate of exhaust gas through the second EGR route, the program configured to:
determine a first setpoint value for a total amount of exhaust gas requested into the intake manifold;
determine a second setpoint value for a parameter representative of a relationship between the total amount of exhaust gas requested into the intake manifold, an amount of exhaust gas from the first EGR route, and the amount of exhaust gas from the second EGR route;
apply said first setpoint value and the second setpoint value to a control routine for adjusting the regulator;
determine a third setpoint value for a temperature within the intake manifold;
determine an actual temperature within the intake manifold;
calculate an error between said actual temperature and the third setpoint value; and
generate a correction index (I) using said error for application to the second setpoint value in order to reduce said error.

17. The computer readable medium embodying a computer program product according to claim 16, wherein said second setpoint value is empirically determined and correlates said parameter to a plurality of engine operating parameters.

18. The computer readable medium embodying a computer program product according to claim 16, wherein said third setpoint value is empirically determined and correlates the temperature within the intake manifold to a plurality of engine operating parameters.

19. The computer readable medium embodying a computer program product according to claim 18, wherein said plurality of engine operating parameters are chosen from a group comprising engine speed, engine load or engine coolant temperature.
